(19) United States
(12) Patent Application Publication
(10) Pub. No.: US 2022/0304879 A1
(43) Pub. Date: Sep. 29, 2022

(54) LIMB POSITIONING SYSTEM

(71) Applicant: GANYMED ROBOTICS, Paris (FR)

(72) Inventors: Margot Guillouard, Paris (FR); Thomas Clause, Paris (FR); Blaise Bleunven, Paris (FR); Sophie Cahen, Paris (FR)

(73) Assignee: GANYMED ROBOTICS, Paris (FR)

(21) Appl. No.: 17/704,335

(22) Filed: Mar. 25, 2022

(30) Foreign Application Priority Data
Mar. 25, 2021 (EP) 21305375.4

(51) Int. Cl. A61G 13/12; A61G 13/10; A61G 13/00

(52) U.S. Cl. CPC A61G 13/1245; A61G 13/101; A61G 13/0063; A61G 13/1295; A61G 2200/327; A61G 2203/78; A61G 2210/10

(57) ABSTRACT

A limb positioning system for positioning and maintaining immobilized a patient's limb in a desired position with respect to a surgical table during orthopedic surgery. The system includes: a pivoting member having a longitudinal portion extending along a corresponding longitudinal axis; a support member configured to support the patient's limb; the support member includes a support hooking part connected to the longitudinal portion and movable along the longitudinal portion; a clutch connected to the pivoting member having an open configuration and a locked configuration, wherein, in the open configuration, the clutch enables pivoting of the pivoting member around a rotation axis that is parallel to the longitudinal axis, distinct from the longitudinal axis, and wherein, in the locked configuration, the clutch allows immobilization of the pivoting member in the desired position; and at least one fixation member configured to maintain the system in position with respect to the surgical table.

### FIELD

The present invention relates to the field of surgical support system. In particular, the present invention relates to the field of systems for positioning and maintaining immobilized a limb of a patient in a desired position with respect to a surgical table during orthopedic surgery.

### BACKGROUND

During last decades surgery operations have been improved by the use of technical devices, whose purpose is to help the surgeon in his practice. Specifically, in orthopedic surgery, one of the main problems is how to position and immobilize a limb to be operated.

Different solutions have been developed along the years to solve the problem of positioning and immobilization for surgical operation, notably for operation of the knee such as for example knee arthroplasty (i.e., surgical procedure to resurface a knee damaged by arthritis). In this type of surgery is it important for the surgeon to perform ligament balancing evaluation of the patient's leg in extension and in flexion (i.e., medial extension, medial flexion, lateral extension, and lateral flexion gaps and ligament tensions) which helps to well balance the knee of the patient on its biomechanical functions. A patient with a balanced knee is more likely to have increased range of motion and proprioception, and decreased pain. In order to perform the ligament balancing the surgeon need to freely move the leg. Therefore, the immobilization of the leg has to be easily undone during the surgery. The surgeon may want as well during the surgery to put the leg in a hyper-flexion position wherein the calf is put in contact with the thigh.

One proposed solution is the use of a leg stabilizer located under the foot. Such a leg stabilizer consists of a support element (i.e., a cushion) which is located on the surgical table so that, when the sole of the foot rests on said support element, the leg is maintained in a desired flexion position, wherein the thigh and the calf forms an angle inferior to 180 degrees. A second support element may be further placed on a side of the leg, to prevent the leg from falling on external side of the surgical table. This solution is simple (static and fully manual), easy to use and compact. The surgeon can easily release the leg from the previously set flexion position. It is then easy to make the ligament balancing evaluation of the patient's leg in extension. However, the leg is not firmly attached and maintained at a dedicated flexion position (i.e., not immobilized). This solution does not strain the leg fully, the flexion position obtained is approximative and the holding into position is loosy.

Other solutions involve the use of systems comprising a dedicated foot piece configured to support the foot of the patient and a fixation base on which said foot piece is fixed, said fixation base being fixed on the surgical table. Some of these systems allow a continuous linear setting, while others have discrete adjustments with notches or holes. The immobilization is more reliable and rigid than the leg stabilizer with cushions described above. However, these systems present multiples disadvantages: (1) they require an adaptation of the operating table (i.e., some parts of the table need to be removed), (2) they do not allow a full leg hyper flexion because the calf is surrounded by the foot piece, and therefore it can't be completely pressed against the thigh, (3) the leg cannot be easily released from such systems when the surgeon wants to evaluate the ligament balancing (i.e., the leg can't be manipulated freely or by the foot, unless the user detaches the foot from the system, which is a considerable loss of time).

A further solution is proposed by patent EP 1 940 337 B1 which proposes a system allowing the positioning and holding of the leg in a flexion position using a cradle supporting the limb of the patient (by the thigh) with respect to the lateral rail of the surgical table and means for positioning said cradle with respect to multiple axis. However, the system of this patent presents some disadvantages: (1) many backlashes in the settings which reduce the rigidity of the leg immobilization, (2) the range of motion of the cradle is not symmetric, therefore a mechanical operation is necessary in order to pass from a configuration for operating a left leg to a configuration for operating a right leg (or the inverse), (3) the adjustment and adaption of the system to the patient is difficult because of the numerous and discrete settings which are not intuitive and not easy to understand (i.e., a training and learning phase is necessary to properly mount and adjust said system), (4) the use of a cradle under the thigh makes impossible for the surgeon to set the leg in the hyper flexion position while the leg is attached to the system and (5) the system is commanded by the user through foot pedals, which is prone to errors and misuse during surgery.

The system of the present invention provides a solution for here-above mentioned issues by using a simpler structure which is more ergonomic and easier to use for the surgeon.

### SUMMARY

The present invention relates to a limb positioning system for positioning and maintaining immobilized a limb of a patient in a desired position with respect to a surgical table during orthopedic surgery. The system comprising:
a pivoting member having a longitudinal portion extending along a corresponding longitudinal axis, said pivoting member being configured so that, when the system is fixed on the surgical table, said longitudinal axis is parallel to the surgical table;
a support member configured to support the limb of the patient; said support member comprises a support hooking part connected to said longitudinal portion and movable along said longitudinal portion;
a clutch connected to the pivoting member having an open configuration and a locked configuration, wherein, in the open configuration, the clutch enables pivoting of the pivoting member around a rotation axis that is parallel to the longitudinal axis, distinct from the longitudinal axis, and wherein, in the locked configuration, the clutch allows immobilization of the pivoting member in the desired position;
at least one fixation member configured to maintain the system in position with respect to the surgical table.

Advantageously, the present invention provides a system that, thanks to the configuration of the clutch and the pivoting member, allows an easily immobilization of a limb in a desired position during a surgical operation, which increases precision of gestures, and easily release of the limb so as to allow the surgeon to freely manipulate the limb during the operation. This manipulation helps the surgeon in its operation and ensures in fine that the patient will regain natural movement of the limb after surgery. Moreover, the present system is compact which leaves more free space to the surgeon for the manipulation of the limb and during the surgery. Furthermore, the range of motion allowed by the pivoting member of the system to position the limb is symmetrical, thus the system may be easily installed without needing any further tuning for operating on the left or the right limb alternatively, thus mounted on the left or right side of the surgical table. This advantageously allows operating left and right limb (for example knees) successively implementing minor changes to the system and thus saving time during the surgery. Globally, the different features of the invention cooperate so as to provide a system which is easily adaptable to the patient with little adjustments required, this advantageously reduces the time necessary to install the patient in a configuration for the surgery. Moreover, the configuration of the clutch and the pivoting member allows to position and secure the limb of the subject to the system so that the rotational axis passes through the center of the hip of the subject. This advantageously allows the surgeons, when the clutch is in the open configuration, to easily manipulate the limb of the subject passing from a flexed to a stretched position, and vice versa, without moving the upper portion of the body of the subject and/or without demanding tuning of any other component of the system. Only the angle between the pivoting element and the table variates, no other modification of the system is required. This allows the surgeon to take in hand the limb without having any component of the system that comes in the way and/or that needs to be adjusted to allow free manipulation of the limb.

Furthermore, the use of a fixation member configured to maintain the system in position with respect to the surgical table (instead for example of the systems maintained by a base structure positioned directly on the floor) allows to install the system to any standard surgical table without need to modify the surgical table itself. Finally, the simplicity of the system simplifies the manufacture of the system and allows to reduce cost of production.

The limb positioning system according to the invention may comprise one or several of the following features, taken in isolation or combined with each other:

According to one embodiment, the pivoting member is movable relative to the clutch for varying a distance between the longitudinal axis and the rotation axis. This embodiment advantageously allows to adapt the system to different morphologies of patients, notably to adapt the system to the height of the patient's limb.

According to one embodiment, the fixation member is configured to clamp the system to the surgical table, preferably to a rail of the surgical table, so that no change of the surgical table is required. The fixation member may be adapted to be clamped onto the existing surgical table through the rails.

According to one embodiment, the fixation member comprises a setting module configured to modify the position of the pivoting member, the support member and the clutch in a plane orthogonal to the rotation axis. The fixation member advantageously allows to align the rotational axis to a predefined anatomical reference of the patient, for example the center of the hip of the subject, whenever the limb to be operated is a leg.

According to one embodiment, the system further comprises a weight compensation device configured to provide a weight compensation force to the pivoting member, said force being opposed to a weight of the limb applied to the pivoting member. Indeed, the clutch is only configured to be in an open configuration and a locked configuration. The weight compensation device advantageously allows to assist the surgeon to reposition the limb with ease when the clutch is in the open configuration so that the surgeons does not have to support all the weight of the limb.

According to one embodiment, the weight compensation device is a passive device, preferably a spring, or an active device, such as an actuator.

According to one embodiment, the support member comprises a hanging element that is positioned with respect to the pivoting member so that, when the system is in use, the limb is hanged (or suspended) from the longitudinal portion of the pivoting member. Preferably, the hanging element may be releasably connected to said longitudinal portion via the support hooking part. Said hanging element may be an annular part. In this particular embodiment, the longitudinal portion is always placed on top of the limb, which advantageous allow to free the space between the hanged limb and the surgical table from any disturbing element. Furthermore, this configuration allows to have the anterior part of the limb free from any cumbersome mechanism (i.e., only hanging element present), which allows the surgeon to perform a wider range of movement with the limb. When the limb is a leg, hyper-flexion of the leg is thus permitted, so as full extension of the leg on the surgical table.

According to one embodiment, the support member comprises an annular part configured to surround the limb, wherein the annular part is positioned with respect to the pivoting member so that the limb is hanged (or suspended) on the longitudinal portion of the pivoting member using the annular part. This particular arrangement, having the pivoting member placed on top of the limb, is advantageous as it frees the space between the hanged limb and the surgical table from any disturbing element. Moreover, this configuration allows to have the anterior part of the limb free from any cumbersome mechanism (i.e., only annular part present), which allows the surgeon to perform a wider range of movement with the limb. When the limb is a leg, hyper flexion of the leg is thus permitted, so as full extension of the leg on the surgical table.

According to one embodiment, the support hooking part is connected to the annular part and is detachable from the longitudinal portion of the pivoting member. This embodiment enables a quick release of the patient in case of an emergency stop of the procedure. This embodiment further simplifies the installation of the support member.

According to one embodiment, the system further comprises a bone grasping support having a first portion fixed to the pivoting member and comprising, at one end of a second portion, a grasping member configured to be rigidly fixed to at least one bone of the patient. This embodiment advantageously allows to hold in place the bone to be operated with respect to the system, which is extremely important during orthopedic surgeries.

According to one embodiment, the clutch is a brake, preferably an electromagnetic power off brake. The use of a brake is much more advantageous than using a gear motor since they comprise a lot of fragile moving parts that are subject to mechanical wear, they are more compact, easy to design and to manufacture.

According to one embodiment, the system comprises a switching member for switching the clutch between the open configuration and locked configuration.

In one embodiment, the switching member is located below the rotation axis and at a predetermined distance from the floor when the system is in a normal use configuration. This specific location of the switching member allows the surgeon and/or a member of the medical staff to push the switching member with a part of his/her leg so as to keep the hands free to manipulate the limb. For example, the switching member may be located at a height allowing a person to push it with his/her knee.

Alternatively, the switching member may be a foot switch configured to be placed on the floor.

In one embodiment, the switching member comprises two switches located respectively on both sides of the fixation member. This embodiment allows the surgeon and/or a member of the medical staff to activate/disactivate the clutch by pushing on the switching member from both sides of the fixation member. In this embodiment the switches are advantageously in a symmetrical position with respect to rotation axis, so that the surgeon operating the right or left limb will be able to activate/disactivate the clutch with the same movement which is cognitively easier.

The present invention also relates to an assembly comprising a limb positioning system according to any one of the embodiments described above and a surgical robotic device, wherein the limb positioning system and robotic device are connected to each other.

In one embodiment, the surgical robotic device comprises at least one movable member configured to pivot around a rotation axis coinciding with the rotation axis of the pivoting member of the limb positioning system.

In one embodiment, the surgical robotic device is a surgical assistance robotic device for knee joint arthroplasty.

### BRIEF DESCRIPTION OF THE DRAWINGS

The following detailed description will be better understood when read in conjunction with the drawings. For the purpose of illustrating, the system and assembly is shown in the preferred embodiments. It should be understood, however that the application is not limited to the precise arrangements, structures, features, embodiments, and aspect shown. The drawings are not drawn to scale and are not intended to limit the scope of the claims to the embodiments depicted. Accordingly, it should be understood that where features mentioned in the appended claims are followed by reference signs, such signs are included solely for the purpose of enhancing the intelligibility of the claims and are in no way limiting on the scope of the claims.

Features and advantages of the invention will become apparent from the following description of embodiments of a system, this description being given merely by way of example and with reference to the appended drawings in which:

FIG. 1 is a perspective view of the system coupled to one leg of a patient according to an embodiment of the invention.

FIG. 2 is a top view of the system of the invention coupled to one leg of a patient.

FIG. 3 is a lateral view of the system of the invention coupled to one leg of a patient according to an embodiment of the invention.

FIG. 4 is a schematic representation of different positions in which the leg of the patient can be placed when using the system of the invention.

FIG. 5 is a schematic representation of the movements that may be permitted on the leg, when the system of the invention is coupled to one leg of a patient.

FIG. 6 is a schematic representation of the surgeon manipulating the leg of the patient when the system is in a locked configuration.

FIG. 7 is a perspective view of the system comprising a bone grasping support.

FIG. 8 is a perspective view of the assemble of the present invention.

While various embodiments have been described and illustrated, the detailed description is not to be construed as being limited hereto. Various modifications can be made to the embodiments by those skilled in the art without departing from the true spirit and scope of the disclosure as defined by the claims.

### DETAILED DESCRIPTION

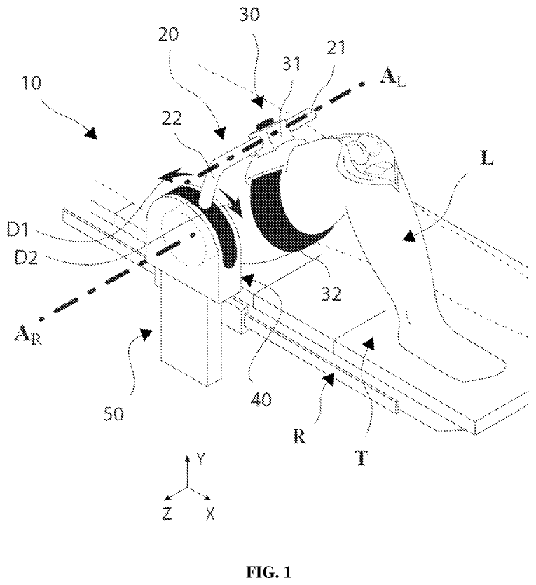

A limb positioning system 10 according to an embodiment of the present invention will now be described with reference to FIG. 1.

As shown in FIG. 1, the limb is a leg L of the patient and the positioning system 10 comprises a pivoting member 20, a support member 30 configured to support the limb of the patient, a clutch 40 connected to the pivoting member 20 and a fixation member 50.

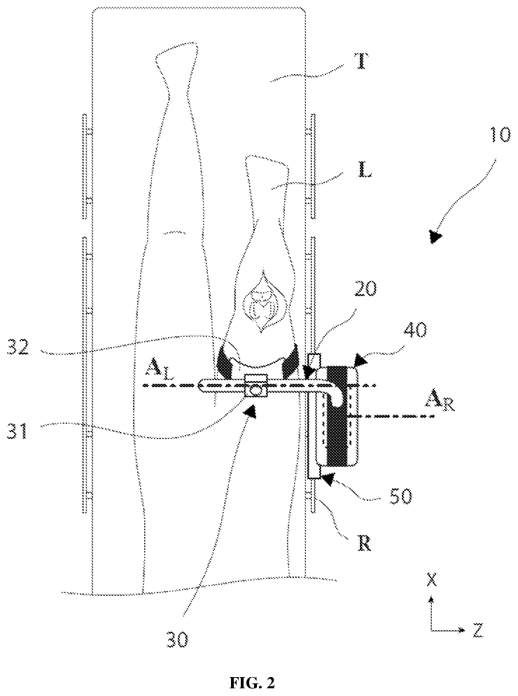

In this first embodiment, the pivoting member 20 has a longitudinal first portion 21 extending along a corresponding longitudinal axis A_{L}. The pivoting member is configured so as that, when the system is in a normal use configuration, the longitudinal axis A_{L} always belong to a plane parallel to the surgical table T, no matter the position of the pivoting member 20 with respect to the table T. As shown in FIG. 1, the pivoting member 20 may comprise a second portion 22 that connects the longitudinal portion 21 to the clutch 40. In this example, the second portion 22 is substantially perpendicular or transversal to the longitudinal portion 21 and the longitudinal axis A_{L}. The longitudinal axis A_{L} extends in direction Z (FIG. 2).

Alternatively, the longitudinal portion 21 extending along a corresponding longitudinal axis A_{L} may be directly connected to the clutch (not represented).

In order to set properly the pivoting member 20 towards the clutch 40, the second portion 22 can be adjusted by varying a distance between the longitudinal axis A_{L} and the rotation axis A_{R}. In one embodiment, multiple pivoting member 20 with a various length for the second portion 22 may be available to be coupled with the clutch. The surgeon will have to choose the length of the second portion according to the morphology of the patient.

Alternatively, the clutch 40 may be configured to receive a part of variating length of the second portion 22, the length of the part inserted into the clutch 40 being determined by the surgeon to fit the morphology of the patient.

In this embodiment, the support member 30 comprises a support hooking part 31 connected to said longitudinal portion 21 and a hanging element configured to receive and support the limb. Said hanging element is positioned with respect to the pivoting member so that, when the system is in a normal use configuration, the limb is hanged (or suspended) from the longitudinal portion of the pivoting member. As shown in the figures, the hanging element may be an annular part 32 configured to receive and support the limb, said annular part 32 being movably connected to the said longitudinal portion 21 through the support hooking part 31. The annular part 32 is connected to the support hooking part 31 so that when the limb is correctly placed into the annular part 32, said limb is hanged from the longitudinal portion 21 of the pivoting member 20. In the embodiment wherein the limb is a leg, the annular part 32 is configured to be fastened around the thigh of the patient. This is particularly advantageous since thanks to this configuration hanging the thigh, the area between the anterior part of the thigh, the calf and the surgical table is free from any obstacle, so that the surgeon performing a knee arthroplasty surgery can put the leg of the patient either in hyper flexion (i.e., calf in contact with the rear of the thigh), flexion or full extension (i.e., leg elongated laying on the table) with ease and without any disturbance. This embodiment also advantageously allows an easier take in hand of the limb by the surgeon as no component of the system prevents the surgeon to place his/her hands on any anterior part of the limb to lift it and perform the desired manipulation.

The annular part 32 may be a strip of fabric comprising fastening means allowing to close the strip into the annular shape, forming the annular part 32. Multiple fastening means, such as for example Velcro straps, may be positioned into both extremities of the strips in order to allow the strip to be closed into an annular part 32 so as to better adapt to the morphology of the patient. The annular part 32 may be an orthosis.

In this embodiment, the support hooking part 31 is movable along said longitudinal portion 21 so that the position of the support member 30 can be easily adjusted to each specific patient, and may be then clamped (not represented) to block the position of the support member 30 along the longitudinal axis A_{L}

The support hooking part 31 may be detachably connected to the annular part 32 so that the annular part 32 hanging the limb may be detachable at any moment from the longitudinal portion 21. The support hooking part 31 may comprise a switch or a pushbutton that once pushed frees the annular part 32 from the support hooking part 31. This feature is particularly advantageous since it allows to quickly release the patient from the system in case of an emergency stop of the surgical procedure.

In this embodiment, the clutch 40 is a brake configured to reversibly switch between an open configuration and a locked configuration. In the open configuration, the clutch does not apply any force on the pivoting member 20 which is therefore free to turn around the rotation axis A_{R} in both directions D1 and D2, the limit to this movement being imposed by the presence of the surgical table T when the system is in a normal use configuration and eventually by the presence of the limb L if the system is connected to the patient.

The clutch may be configured to allow the pivoting element to cover an angle range of 180 degrees when no patient is connected to the support element 30. When a leg of the patient is connected to the support element 30, the pivoting element 20 can cover, for example, an angle range of 20 to 90 degrees.

In the locked configuration, the brake of the clutch is activated and the pivoting member 20 is immobilized in a desired (angular) position so that the limb L of the patient is hanged in a desired position.

As shown in FIG. 1, when the system is adapted to support a leg, it does not comprise any support to fix the corresponding foot in a predefine position; the foot is simply placed on the surgical table at an adequate distance from the thigh. The surgeon may find the most suitable configuration of the leg for each step of the surgical procedure, being free to change said configuration at any moment.

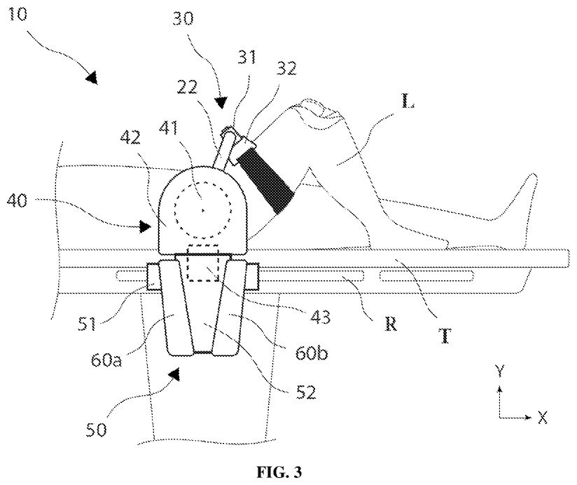

In this embodiment, the system is maintained in position with respect to the surgical table T thanks to the fixation member 50. The fixation member 50 may be a monoblock or as a single piece, which therefore allows to fix the system in only one position with respect to the surgical table. Alternatively, the fixation member 50 may comprise a setting module allowing a fine tuning of the position of the system with respect to the surgical table T. This alternative will be described in details in association to FIG. 3.

FIG. 2, which provides a top view of the system of the invention, clearly shows that the rotation axis A_{R} is parallel to the longitudinal axis A_{L}. Furthermore, FIG. 2 shows as well the surgical table T and the rail R of the surgical table, which are not part of the system.

In this embodiment, the fixation member 50 is configured to clamp the system to the surgical table T. The fixation member 50 may be notably configured to be fixed on one rail R of the surgical table. The fixation member 50 may further comprise a setting module shown in FIG. 3.

FIG. 3 is a side view of the system 10. Notably, FIG. 3 is here used to describe the setting module which is configured to modify the position of the pivoting member 20, the support member 30 and the clutch 40 in a plane orthogonal to the rotation axis (A_{R}). More in details, the setting module comprises a first platform 51 which is configured to modify the position of the system, once fixed on the surgical table, along a longitudinal direction X of the surgical table (i.e., horizontally with respect to the floor). This first platform 51 may be configured to be the portion of the fixation element that is able to clamp the system 10 to the surgical table T, for example by means of clips. The setting module comprises as well a second platform 52 configured to displace the system 10 along a vertical direction Y (i.e., a direction parallel to an axis perpendicular to the surgical table T plane). The second platform 52 may comprise a crank handle or be motorized in order to obtain the vertical displacement. The second platform 52 may be fixed onto the first platform 51, and be connected to the clutch 40. These X and Y settings will advantageously allow to align the rotation axis A_{R} of the clutch 40 to the anatomic rotation center of the limb, more precisely, when the limb is a leg, to the hip center in the described example.

FIG. 3 shows as well that the clutch 40 may comprise an external housing 42 configured to comprise and protect from the external environment, the brake 41 and at least part of the weight compensation device 43.

The brake 41 may be electromagnetic brake, more precisely electromagnetic power-off brake, meaning that the brake is into its locked configuration when no electrical current flows through it. Advantageously, a permanent magnet inside said brake ensures that it remains in its locked configuration when no current flows through it.

Concerning the weight compensation device 43, it is configured to provide a weight compensation force to the pivoting member 20 supporting the limb. Said force is opposed to a weight of the limb, the weight being herein considered as a vector quantity representing the gravitational force acting on the limb. The weight (vector) may have a magnitude depending from a portion of the mass of the limb. Indeed, when the limb is a leg, the foot is usually positioned on the surgical table. This embodiment allows, when the clutch is in the open configuration, to advantageously assists a surgeon to lift the leg, during the positioning of the leg and the setup of the knee, as well as during soft tissue balancing manipulations.

The weight compensation device 43 may be a passive device, such as a spring-based mechanism, which exerts a restoring force whenever the spring is pulled or pushed by the pivoting member 20 which support the weight of the limb. Alternatively, the weight compensation device 43 may be an active device, such as an actuator connected to the pivoting member 20.

In this third embodiment, the system further comprises a switching member (60a, 60b) for switching the clutch between the open configuration and locked configuration. This switching member (60a, 60b) may be located below the rotation axis and at a predetermined distance from the floor when the system is in a normal use configuration so that the surgeon may push the switching member by applying a pressure with his/her knee. As shown in FIG. 3, the switching member comprises two switches 60a and 60b located respectively on both sides of the fixation member. In this example, each switching member 60a or 60b is activated by a substantially horizontal push (i.e. in a direction substantially parallel to the floor or the table T). Alternatively, the switching member may comprise a single switch (not represented) positioned on the external surface of the second platform 52 (i.e., the surface of the second platform 52 that is not facing the surgical table). The advantage of positioning the switching member at the height of the surgeon's knee is that he/she will be able to push the switch with a simple movement of his/her leg while using his/her arms to manipulate the limb of the patient.

Alternatively, the switching member for switching the clutch between the open configuration and locked configuration may be a simple pedal positioned on the floor. However, pushing the switch member with the knee or a part of the thigh (depending on the height of the surgeon) is easier and safer than searching with the feet for a switch disposed on the floor.

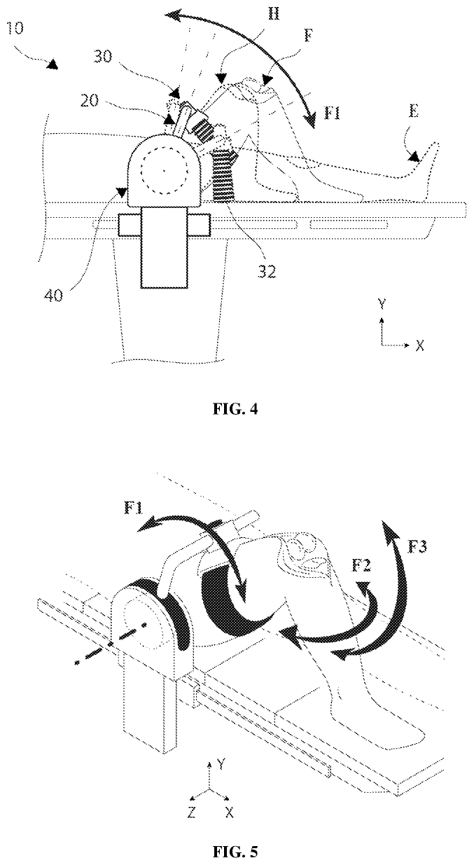

FIG. 4 shows a lateral view of the leg of the patient wherein the thigh is positioned inside the annular part 32 in different positions allowed by the system.

The leg may be disposed in an extension position E (FIG. 4) wherein the leg rests on the surgical table, not applying any force on the support member 30, and the clutch may be therefore in the unlocked configuration. Then, while the clutch is in the unlocked configuration, the surgeon may change the position of the leg to a flexion position F wherein the thigh and the calf forms an angle of less than 180 degrees. As shown in this FIG. 4, the support member 30 and the pivoting member 20 move with the thigh to which they are connected. To maintain the leg in this flexion position F, the clutch is switched to the locked configuration and the feet is positioned in an appropriate emplacement on the surgical table. As already explained above, the specific configuration of the support member 30 allows as well the surgeon to further push the calf against the thigh so as to reach the specific flexion position called hyper-flexion position H. As before, to pass from the flexion position to the hyper-flexion position, the clutch 40 had been switched into the open configuration and switched back to the locked configuration once the hyper-flexion position had been reached. The arrow F1 provide a visual representation of the movement of the pivoting element 20 and the thigh of the patient when changing from the extension position E to a flexion position (F, H) and inversely.

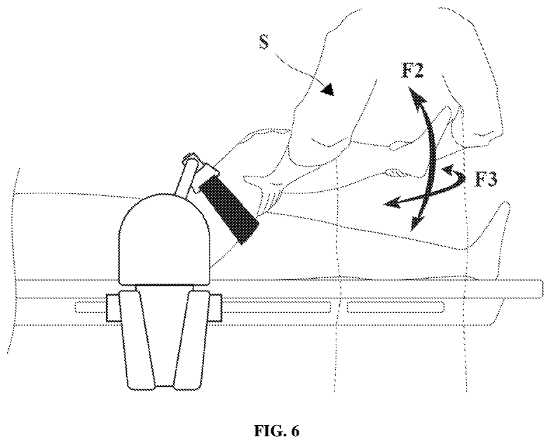

FIG. 5 provides a perspective view of the system, showing with the arrow F1 the pivoting movement of the thigh around the rotation axis. This pivoting movement is allowed by the support element 20 turning around the rotation axis when the clutch is in the open position. Arrows F2 and F3 represents the direction of displacement of the calf during manipulation of the leg by the surgeon (hands of the surgeon are represented manipulating the leg in FIG. 6), when the clutch is in the locked configuration.

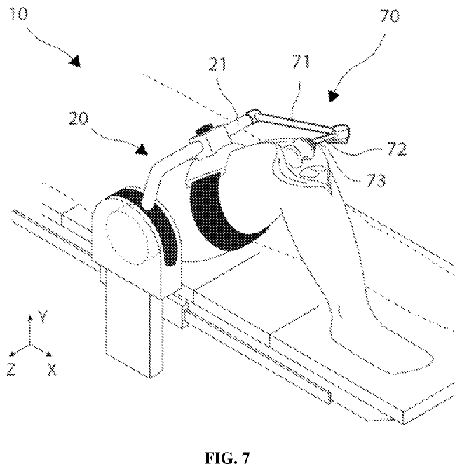

FIG. 7 shows a configuration wherein the system 10 further comprises a bone grasping support 70 to rigidly fix a bone of the patient in a desired position. In this example, the bone grasping support 70 has a first portion 71 fixed to an end of the pivoting member 20 opposite to the clutch 40, and comprises a second portion 72 hinged connected to said first portion 71. The end of the second portion 72 opposite to the hinged connection comprises a grasping member 73 configured to be rigidly fixed to at least one bone of the patient. The first portion 71 extends here in a direction transversal to the longitudinal portion 21 of the pivoting member. The hinged connection may comprise a locking element that allows to block the hinged connection in a desired fixed position of the first portion 71 with respect to the second portion 72. This embodiment advantageously allows to first move the first portion 71 and the second portion 72 in order to adapt the bone grasping support 70 to the morphology of the patient, secondly to provide a rigid connection between the pivoting member 20 and the bone when the locking element blocks the first portion 71 and the second portion 72 in the desired fixed position. The grasping member 73 may comprises surgical screws allowing to fix the system for example to the tibia or femur of the patient. Such a bone grasping support 70 is well integrated in the system, thus resulting in a compact design and more room for the surgeon.

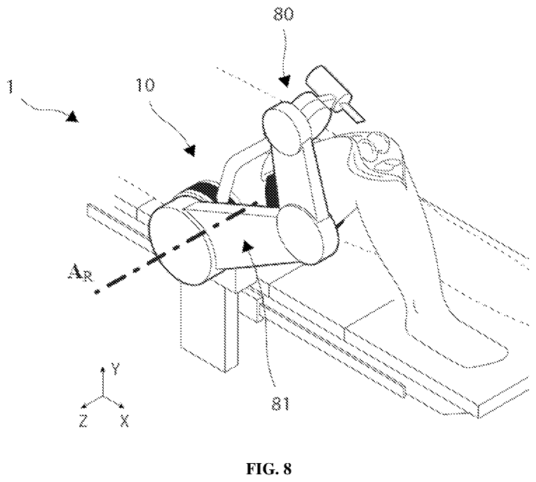

FIG. 8 shows an assembly comprising a limb positioning system 10 according to an embodiment of the invention, and a surgical robotic device 80, wherein the limb positioning system and robotic device are connected to each other's. In this example, the surgical robotic device 80 comprises at least one movable member 81 configured to pivot around a rotation axis coinciding with the rotation axis A_{R} of the pivoting member of the limb positioning system. The robot and the positioning system may thus be referenced relative to a same axis, thus improving precision of the surgical robotic device. Moreover, when such an assembly is used in combination with the bone grasping device 70 (not represented), precision of the robotic device 80 is also improved due to the fixed position of the bone to which the device 70 is attached.

1. A limb positioning system for positioning and maintaining immobilized a limb of a patient in a desired position with respect to a surgical table during orthopedic surgery, said system comprising:
a pivoting member having a longitudinal portion extending along a corresponding longitudinal axis, said pivoting member being configured such that, when the system is in a normal use configuration, said longitudinal axis is parallel to the surgical table;
a support member configured to support the limb of the patient; said support member comprises a support hooking part connected to said longitudinal portion and movable along said longitudinal portion;
a clutch connected to the pivoting member having an open configuration and a locked configuration, wherein, in the open configuration, the clutch enables pivoting of the pivoting member around a rotation axis that is parallel to the longitudinal axis, distinct from the longitudinal axis, and wherein, in the locked configuration, the clutch allows immobilization of the pivoting member in the desired position; and
at least one fixation member configured to maintain the system in position with respect to the surgical table.

2. The limb positioning system according to claim 1, wherein the pivoting member is movable relative to the clutch for varying a distance between the longitudinal axis and the rotation axis.

3. The limb positioning system according to claim 1, wherein the fixation member is configured to clamp the system to the surgical table.

4. The limb positioning system according to claim 3, wherein the fixation member is configured to clamp the system to a rail of the surgical table.

5. The limb positioning system according to claim 1, wherein the fixation member comprises a setting module configured to modify the position of the pivoting member, the support member and the clutch in a plane orthogonal to the rotation axis.

6. The limb positioning system according to claim 1, further comprising a weight compensation device configured to provide a weight compensation force to the pivoting member, said force being opposed to a weight of the limb applied to the pivoting member.

7. The limb positioning system according to claim 5, wherein the weight compensation device is a passive device or an active device such as an actuator.

8. The limb positioning system according to claim 7, wherein the passive device is a spring

9. The limb positioning system according to claim 7, wherein the active device is an actuator.

10. The limb positioning system according to claim 1, further comprising a bone grasping support having a first portion fixed to the pivoting member and comprising, at one end of a second portion, a grasping member configured to be rigidly fixed to at least one bone of the patient.

11. The limb positioning system according to 1, wherein the support member comprises an annular part configured to surround the limb, wherein the annular part is positioned with respect to the pivoting member so that the limb is hanged on the longitudinal portion of the pivoting member using the annular part.

12. The limb positioning system according to claim 11, wherein the support hooking part is detachably connected to the annular part so that the annular part is detachable from the longitudinal portion.

13. The limb positioning system according to claim 1, wherein the clutch is an electromagnetic power off brake.

14. The limb positioning system according to claim 1, further comprising a switching member for switching the clutch between the open configuration and locked configuration, said switching member being located below the rotation axis and at a predetermined distance from the floor when the system is in a normal use configuration.

15. The limb positioning system according to claim 11, wherein the switching member comprises two switches located respectively on both sides of the fixation member.

16. An assembly comprising a limb positioning system according to claim 1 and a surgical robotic device, wherein the limb positioning system and robotic device are connected to each other's.

17. The assembly according to claim 13, wherein the surgical robotic device comprises at least one movable member configured to pivot around a rotation axis coinciding with the rotation axis of the pivoting member of the limb positioning system.
